(19) United States
(12) Patent Application Publication
(10) Pub. No.: US 2023/0108704 A1
(43) Pub. Date: Apr. 6, 2023

(54) TURBOFAN ENGINE

(71) Applicant: Claude JOUVE, SEYSSINS (FR)

(72) Inventor: Claude Jouve, Seyssins (FR)

(21) Appl. No.: 17/798,860

(22) PCT Filed: Feb. 8, 2021
(86) PCT No.: PCT/EP2021/052982

§ 371 Date: Aug. 10, 2022

(30) Foreign Application Priority Data
Feb. 13, 2020 (FR) FR2001434

(51) Int. Cl. F02C 3/073; F02C 3/14

(52) U.S. Cl. CPC F02C 3/073; F02C 3/14; F05D 2220/32; F05D 2240/35

(57) ABSTRACT

A turbofan engine (10), including a ducted fan (22) and an engine (16) having a nozzle (24) for expelling burnt gases (N1) by the engine in the upstream direction of the turbofan engine, the free end (26) of the nozzle being located upstream of the fan (22).

### TECHNICAL FIELD

The present description relates generally to turbofan engines.

### PRIOR ART

The turbofan engine is a propulsion system that transforms the chemical potential energy contained in a fuel, associated with an oxidizer corresponding to the ambient air, into kinetic energy, generating a reaction force, the thrust, in the direction opposite to the ejection. The thrust generated results from the acceleration of a certain amount of air between the inlet (air inlet nozzle) and the outlet (ejection nozzle).

A turbofan engine comprises at least one compressor mechanically linked by a shaft to a turbine. A combustion chamber is provided between the compressor and the turbine. The compressor may comprise a plurality of compressor stages. Similarly, the turbine may comprise a plurality of turbine stages. When all stages of the compressor are turning at the same speed as the turbine, the engine is said to be single-spool. In a dual-spool engine, the turbofan engine comprises a first compressor, called a high-pressure compressor, driven by a first turbine, called a high-pressure turbine, and a second compressor, called a low-pressure compressor, driven by a second turbine, called a low-pressure turbine, the rotational speeds of the first and second compressors being different.

The turbofan engine is said to be single-flow when all the air entering the turbofan engine enters the combustion chamber. The turbofan engine is said to be dual-flow when the air flow entering the turbofan engine is divided into two flows, the primary flow and the secondary flow.

The primary flow, or hot flow, passes through the entire engine via the compressor(s), the combustion chamber, and the turbine(s). The secondary flow, or cold flow, bypasses the entire hot portion of the engine. In some turbofan engines, the secondary flow also drives the low-pressure compressor. Other turbofan engines comprise a fan, which has a diameter much larger than the low-pressure compressor and is located at the front thereof. The fan is driven by the same shaft as the low-pressure compressor. This allows a maximum thrust of the secondary flow to be obtained.

The ratio of the air flow rate of the secondary flow to the air flow rate of the primary flow is called the dilution ratio or dilution rate. In a single-flow turbojet engine, the air circulating in the engine is accelerated very strongly, which leads to a high ejection speed, creating strong turbulence by mixing with the ambient air, resulting in significant noise. On the other hand, in a dual-flow turbofan engine, the large quantity of air passing through the secondary flow is lightly accelerated and “encases” the strongly accelerated primary flow, resulting in a reduction in noise.

However, for some applications, it would be desirable to further reduce the noise emitted by the turbofan engine downstream.

### DESCRIPTION OF THE INVENTION

Thus, one object of one embodiment is to overcome at least some of the disadvantages of the turbofan engines described above.

One object of one embodiment is that the turbofan engine has a reduced noise emission.

To this end, one embodiment provides a dual-flow turbofan engine, comprising a ducted fan and an engine having a nozzle for expelling burnt gases by the engine in the upstream direction of the turbofan engine, the free end of the nozzle being located upstream of the fan.

According to one embodiment, the turbofan is intended to receive a flow of air divided into a primary flow and a secondary flow, the primary flow feeding the engine and forming the burnt gases ejected in the upstream direction of the turbofan engine, the secondary flow being ejected in the downstream direction of the turbofan engine.

According to one embodiment, the turbofan engine comprises a first duct having a first air inlet at least for the secondary flow, the fan being contained in the first duct, the turbofan engine comprising a second air inlet for the primary flow.

According to one embodiment, the second air inlet is located upstream of the first air inlet.

According to one embodiment, the dilution rate of the turbofan engine is between 8 and 15.

According to one embodiment, the nozzle is divergent.

According to one embodiment, the turbofan engine is a dual-spool engine and comprises a low-pressure coupling having at least one low-pressure turbine stage and a high-pressure coupling, wherein a portion of the fan forms the rotor of the low-pressure turbine stage.

According to one embodiment, the turbofan engine comprises first blades, each first blade comprising a first portion and a second portion, the first portions of the first blades forming the rotor of the low-pressure turbine stage and the second portions of the first blades forming the fan.

According to one embodiment, the low-pressure coupling comprises at least one low-pressure compressor stage and another portion of the fan forms the rotor of the low-pressure compressor stage.

According to one embodiment, each first blade further comprises a third portion, the third portions of the first blades forming the rotor of the low-pressure compressor stage.

According to one embodiment, the primary flow passes through the low-pressure compressor stage while the primary flow flows from upstream to downstream of the turbofan engine and the burnt gases pass through the low-pressure turbine stage while the burnt gases flow from downstream to upstream of the turbofan engine.

According to one embodiment, the low-pressure coupling comprises at least a first and second low-pressure turbine stage and a first and second low-pressure compressor stage. A portion of the fan forms the rotor of the first low-pressure turbine stage, the turbofan engine comprising second blades, each second blade comprising a first portion and a second portion, the first portions of the second blades forming the rotor of the second low-pressure turbine stage and the second portions of the second blades forming the rotor of the second low-pressure compressor stage.

According to one embodiment, the turbofan engine further comprises movable flaps and a mechanism for actuating the movable flaps between a first position, in which the movable flaps allow burnt gases to be expelled in the upstream direction of the turbofan engine, and a second position, in which the movable flaps open up openings for expelling the burnt gases in the downstream direction of the turbofan engine.

### BRIEF DESCRIPTION OF THE DRAWINGS

These and other features and advantages will be discussed in detail in the following description of particular embodiments, in a non-limiting manner in relation to the appended figures, in which:

FIG. 1 shows an embodiment of a turbofan engine;

FIG. 2 shows another embodiment of a turbofan engine;

FIG. 3 shows an embodiment of a portion of the turbofan engine shown in FIG. 1;

FIG. 4 is a schematic, partial and perspective view of an embodiment of a blade;

FIG. 5 shows another embodiment of a portion of the engine of the turbofan engine shown in FIG. 1;

FIG. 6 shows another embodiment of a portion of the engine of the turbofan engine shown in FIG. 1;

FIG. 7 shows a more detailed embodiment of the turbofan engine shown in FIG. 1;

FIG. 8 shows a more detailed embodiment of the turbofan engine shown in FIG. 2;

FIG. 9 is a schematic, partial and perspective view of another embodiment of a blade;

FIG. 10 shows a variant of the turbofan engine shown in FIG. 7 in a first operating mode;

FIG. 11 shows a variant of the turbofan engine shown in FIG. 7 in a second operating mode;

FIG. 12 shows a variant of the turbofan engine shown in FIG. 8 in a first operating mode; and

FIG. 13 shows a variant of the turbofan engine shown in FIG. 8 in a second operating mode.

### DETAILED DESCRIPTION OF THE EMBODIMENTS

The same elements have been designated by the same reference numerals in the various figures. In particular, the structural and/or functional elements common to the various embodiments may have the same references and may have identical structural, dimensional, and material properties. For the sake of clarity, only those steps and elements that are useful for understanding the described embodiments have been shown and are detailed. In particular, the structures of the turbines, the combustion chamber, and the compressors of turbofan engines are well known to a person skilled in the art and are not described in detail.

Unless otherwise specified, the terms “upstream” and “downstream” refer to the airflow entering the turbofan engine. Unless otherwise specified, the terms “about”, “approximately”, “substantially”, and “in the order of” mean to within 10%, preferably to within 5%.

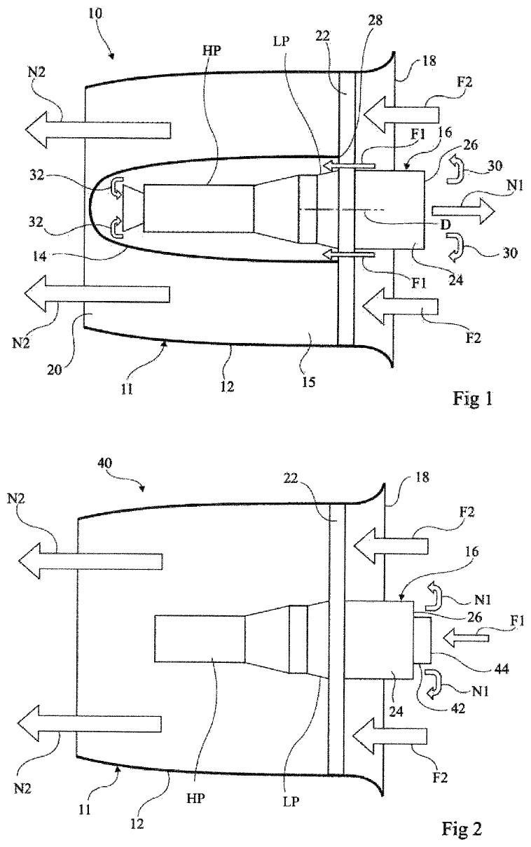

FIG. 1 is a schematic, partial, and cross-sectional view of an embodiment of a turbofan engine 10. The turbofan engine 10 comprises a nacelle 11 comprising an outer duct 12 and an inner duct 14, the outer duct 12 delimiting a channel 15 extending in a direction D and containing the inner duct 14. The channel 15 may be substantially rotationally symmetrical about the axis D. The turbofan engine 10 comprises an engine 16 arranged at least partially in the channel 15 and in the inner duct 14. Beams (not shown) connect the outer duct 12, the inner duct 14, and the engine 16.

The turbofan engine 10 is a dual-flow engine. The airflow feeding the turbofan engine 10 is divided into a primary flow F1 and a secondary flow F2. The engine 16 is fed by the primary flow F1. The outer duct 12 comprises an air inlet 18 and a nozzle 20. The primary flow F1 and the secondary flow F2 enter the turbofan engine 10 through the air inlet 18. The primary flow F1 which feeds the engine 16 is discharged in the form of a burnt gas output flow N1. The turbofan engine 10 expels an air flow N2 in the downstream direction through the nozzle 20. The turbofan engine 10 comprises a fan 22, driven in rotation about an axis D by the engine 16. The fan 22 drives the secondary flow F2 to obtain the expelled flow N2 with the desired thrust.

According to one embodiment, the burnt gas output flow N1 is expelled in the upstream direction of the turbofan engine 10. The engine 16 comprises a nozzle 24 having an end 26 through which the burnt gas outlet flow N1 is expelled, and the end 26 of the nozzle 24 is located upstream of the fan 22. Preferably, the end 26 of the nozzle 24 is located upstream of the air inlet 18 of the outer duct 12.

In the embodiment shown in FIG. 1, the inner duct 14 comprises an air inlet 28 for the primary flow N1. According to one embodiment, the air inlet 28 of the inner duct 14 is located downstream of the air inlet 18 of the outer duct 12, for example downstream of the fan 22. In the embodiment shown in FIG. 1, the air inlet 28 of the inner duct 14 is located just downstream of the fan 22. Alternatively, the air inlet 28 of the inner duct 14 may be located further downstream from the fan 22.

According to one embodiment, the expelled flow N2 is composed substantially entirely of the secondary flow F2. According to one embodiment, at least some (arrow 30) of the burnt gas output flow N1 can be redirected, after being expelled from the nozzle 24, into the secondary flow F2 and/or into the primary flow F1 However, because the burnt gas output flow N1 is expelled upstream of the turbofan engine 10, the part of the burnt gas flow N1 which is redirected into the secondary flow F2 and/or into the primary flow F1 is agitated by the fan 22 such that it is largely diluted in the secondary flow F2.

According to one embodiment, the engine 16 is a dual-spool engine. The engine thus comprises a high-pressure coupling HP and a low-pressure coupling BP, shown very schematically in FIG. 1. The high-pressure coupling HP comprises a high-pressure compressor and a high-pressure turbine (not shown), and the low-pressure coupling BP comprises a low-pressure turbine and optionally a low-pressure compressor (not shown). The engine 16 further comprises a combustion chamber (not shown), located between the high-pressure compressor and the high-pressure turbine. According to one embodiment, the primary flow F1 flows from upstream to downstream as it enters the air inlet 28 and is then diverted so as to flow from downstream to upstream, which is illustrated by the arrows 32. According to one embodiment, the primary flow passes through the high-pressure coupling HP as it flows from downstream to upstream. Furthermore, in the embodiment shown in FIG. 1, the primary flow also passes through the low-pressure coupling BP as it flows from downstream to upstream.

FIG. 2 is a schematic, partial, and cross-sectional view of another embodiment of a turbofan engine 40. The turbofan engine 40 comprises all the elements of the turbofan engine 10 shown in FIG. 1, with the difference that the inner duct 14 is not present and that the engine 16 comprises a conduit 42 comprising an air inlet 44, into which the primary flow F1 enters. In the embodiment shown in FIG. 2, the air inlet 44 is upstream of the air inlet 18 of the outer duct 12. In the embodiment shown in FIG. 2, the air inlet 44 is upstream of the end 26 of the nozzle 24. Advantageously, the primary flow F1 does not comprise any burnt gases from the burnt gas output flow N1. In the present embodiment, the primary flow F1 passes through the low-pressure compressor as it flows from upstream to downstream in the conduit 42. As previously described, the primary flow is then diverted and passes through the high-pressure stage as it flows from downstream to upstream.

In the embodiments shown in FIGS. 1 and 2, the burnt gas output flow N1 is expelled in the upstream direction of the turbofan engine 10 or 40. The noise perceived by an observer to the side of the nozzle 20 discharging the expelled air flow N2 is therefore reduced. For example, in the case where the turbofan 10 or 40 equips a drone, for example for transporting objects, the axis D of the turbofan engine 10 or 40 may, in certain operating configurations, be slightly inclined with respect to a vertical direction, with the end of the nozzle 20 oriented toward the ground. The embodiments of the turbofan engine 10 or 40 thus allow the noise perceived by an observer on the ground to be reduced. In the embodiments shown in FIGS. 1 and 2, the nozzle 24 for expelling the burnt gas flow N1 is shown schematically with a constant cross section. However, it may be advantageous for the nozzle 24 to have a diverging cross section as it approaches the free end 26, to further minimize the residual thrust of the burnt gas flow N1. According to one embodiment, the thrust of the burnt gas flow N1 is less than 15%, preferably less than 10%, more preferably less than 5%, of the thrust of the flow N2.

The dimensions of the turbofan engine 10 or 40 will depend on the intended applications. For example, in the case where the turbofan engine 10 or 40 is intended to equip a drone, for example for transporting objects, the characteristics of the turbofan engine 10 or 40 may be as follows:

dilution rate of between 8 and 15, for example equal to approximately 12;

diameter of the inlet 18 of the outer duct 12 between 25 cm and 30 cm, for example equal to approximately 28 cm;

the diameter of the inlet of the inner duct 14 between 11 cm and 13 cm, for example approximately 12 cm;

length of the outer duct 12 measured along the direction D, between 50 cm and 60 cm, for example approximately 55 cm;

distance between the end 26 of the nozzle 24, having an end 26 through which the burnt gas output flow N1 is expelled, and the fan 26, between 10 cm and 15 cm;

velocity of burnt gas flow expulsion N1, between 2 m/s and 5 m/s.

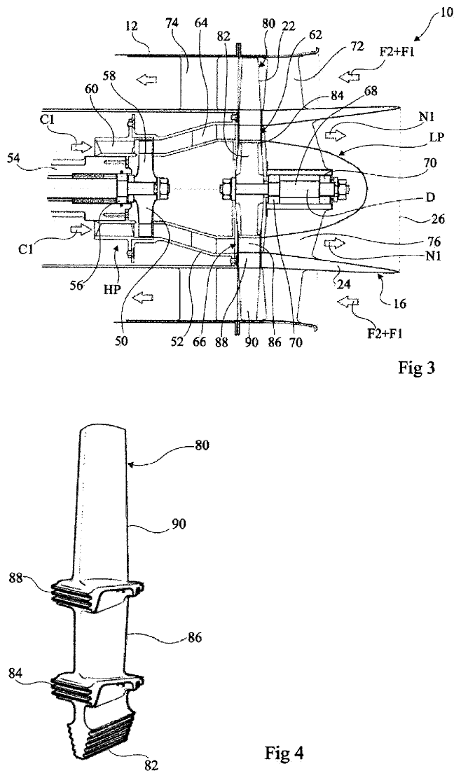

FIG. 3 is a schematic, partial, and cross-sectional view of a more detailed embodiment of a portion of the engine 16 of the turbofan engine 10 shown in FIG. 1. In the present embodiment, the inner duct 14 is not visible. In this embodiment, the high-pressure coupling HP comprises a turbine stage 50. The engine 16 further comprises a frame 52 fixed to the inner duct 14 (not visible) and to the outer duct 16, and a shaft 54, which is mounted so as to be rotatable with respect to the frame 52 about the axis D, by means of bearings 56, only one bearing 56 being visible in FIG. 3. The turbine stage 50 comprises a rotor 58 integral with the shaft 54 and a stator 60 integral with the frame 52. The rotor 58 is driven in rotation by the gas flow (arrow C1) expelled from the combustion chamber (not shown in FIG. 3). The shaft 54 drives in rotation at least one high-pressure compressor stage (not shown) receiving the primary flow N1.

In the present embodiment, the low-pressure coupling BP does not comprise a compressor and comprises a low-pressure turbine stage 62. This turbine stage 62 comprises a stator 64, integral with the frame 52, and a rotor 66. In the present embodiment, the rotor 66 corresponds to the central portion of the fan 22. The rotor 66 is integral with a shaft 68 mounted so as to be rotatable with respect to the frame 52 about the axis D by means of bearings 70. The rotor 66 is driven in rotation about the axis D by the gas flow that has passed through the high-pressure turbine 50. The shafts 68 and 54 may rotate at different rotational speeds and/or in opposite directions.

Connecting elements are arranged between the outer duct 12 and the inner duct 14 and between the inner duct 14 and the frame 52 of the engine 16. Some or all of the connecting elements may act as connecting beams to ensure the cohesion of the turbofan engine 10. Some or all of the connecting elements may correspond to diffusers, also called rectifiers or distributors, used in particular to properly direct the gas flow. For example, FIG. 3 shows connecting elements 72 extending between the outer duct 12 and the inner duct 14 upstream of the fan 22, connecting elements 74 extending between the outer duct 12 and the inner duct 14 downstream of the fan 22, and connecting elements 76 extending between the inner duct 14 and the frame 52 downstream of the low-pressure turbine 60.

FIG. 4 is a perspective view of a blade 80 of the fan 22 of FIG. 3. The blade 80 may correspond to a one-piece part, in particular a cast part. The blade 80 comprises successively, from bottom to top in FIG. 4, a root 82, a first platform 84, the blade portion 86 acting as a turbine rotor blade, a second platform 88, and a blade portion 90 acting as a fan blade. The root 82 is intended to cooperate with an opening provided in the periphery of a disc (not shown) integral with the shaft 68 (not shown), and secures the blade 80 to the shaft 68. When the blades 80 are assembled, the first platforms 84 form a first ring intended to cooperate with the frame 52 to form a sliding, substantially sealed connection. When the blades 80 are assembled, the second platforms 88 form a second ring intended to cooperate with the inner duct 14 to form a sliding, substantially sealed connection. In the present embodiment, it is the central portion of the fan 22, which acts as a low-pressure turbine rotor, that drives the entire fan 22 in rotation about the axis D.

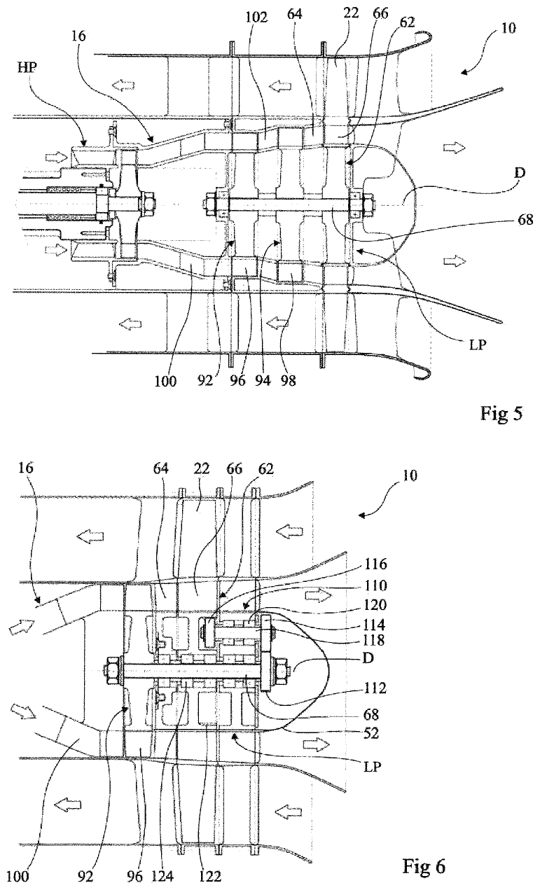

FIG. 5 is a schematic, partial, and cross-sectional view of another more detailed embodiment of a portion of the engine 16 of the turbofan engine 10 shown in FIG. 1. The embodiment of the engine 16 shown in FIG. 5 comprises all of the elements of the engine 16 shown in FIG. 3, with the low-pressure coupling BP comprising two low-pressure turbine stages 92, 94 in addition to the low-pressure turbine stage 62. Each low-pressure turbine stage 92, 94 comprises a rotor 96, 98 driving the shaft 68 and a stator 100, 102 connected to the frame 52.

FIG. 6 is a schematic, partial, and cross-sectional view of another more detailed embodiment of a portion of the engine 16 of the turbofan engine 10 shown in FIG. 1. The embodiment of the engine 16 shown in FIG. 6 comprises all the elements of the engine 16 shown in FIG. 3, with the difference that the rotor 66 of the turbine stage 62 is connected to the shaft via a speed reducer 110. Furthermore, the low-pressure coupling BP comprises an additional low-pressure turbine stage 92 in addition to the turbine stage 62.

The speed reducer 110 may correspond to a gear system. As an example, FIG. 6 shows a gear system comprising three gears 112, 114, 116, of which a first gear 112 rotates integrally with the shaft 68, and a second gear 114 meshes with the first gear 112 and is integral with a shaft 118 mounted so as to be freely rotatable on the frame 52 by means of bearings 120. The third gear 116 is integral with the shaft 118 and cooperates with a crown gear 122 integrated with the fan 22. The fan 22 is mounted so as to be freely rotatable on the shaft 68 by means of bearings 124. The use of the speed reducer 110 allows the rotor 96 of the turbine stage 62 and the fan 22 to rotate at different speeds.

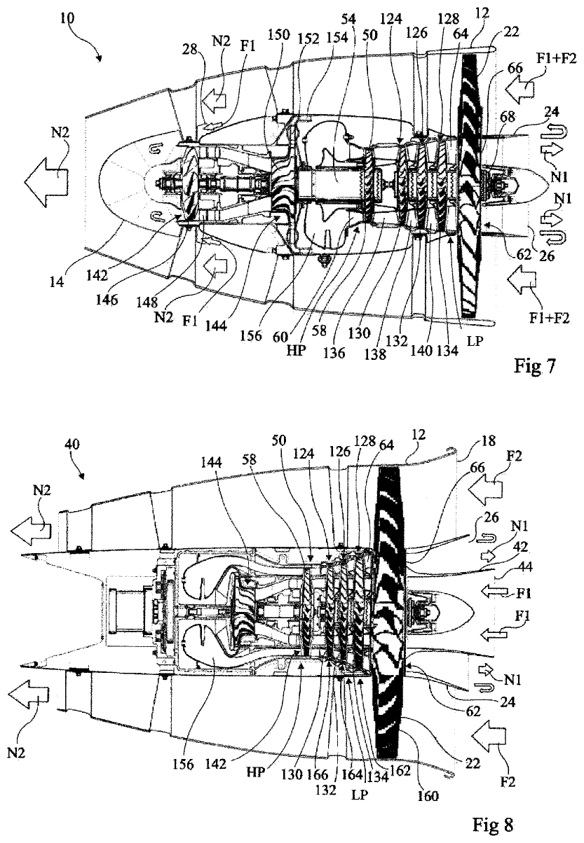

FIG. 7 is a schematic, partial, and cross-sectional view of a more detailed embodiment of the turbofan engine 10 shown in FIG. 1. In the present embodiment, the air inlet 28 of the inner duct 14 is located in the downstream half of the inner duct 14, or even in the quarter part at the downstream end of the inner duct 14. The low-pressure coupling BP comprises the turbine stage 62, including the rotor 22 formed by the central portion of the fan 22 and the stator 64, and three other turbine stages 124, 126, 128. Each low-pressure turbine stage 124, 126, 128 comprises a rotor 130, 132, 134, driving the shaft 68 in rotation, preceded by a stator 136, 138, 140 integral with the frame 52.

The high-pressure coupling HP comprises an axial compressor 142, a radial compressor 144, and the high-pressure turbine stage 50. The axial compressor 142 comprises a rotor 146 followed by a stator 148 and the radial compressor 144 comprises a rotor 150, also referred to as an impeller, followed by a radial diffuser 152 and an axial rectifier 154. The rotors 146, 150 are rotated by the shaft 54. In FIG. 7, the fan 22 and rotors 58, 130, 132, 134, 146, 150 are shown in perspective. The engine 16 comprises an annular combustion chamber 156 between the radial compressor 144 and the high-pressure turbine stage 50. The combustion chamber 154 may be annular or cellular.

FIG. 8 shows a more detailed embodiment of the turbofan engine 40 shown in FIG. 2. In the embodiment shown in FIG. 8, the free end 26 of the nozzle 24 for expelling the burnt gas output flow N1 is located upstream of the inlet opening 18 of the outer duct 12. Alternatively, the free end 26 of the nozzle 24 may be located upstream of the air inlet 18 of the outer duct 12 as shown in FIG. 2. The low-pressure coupling BP comprises the turbine stage 62 and the other three low-pressure turbine stages 124, 126, 128 previously described in relation to FIG. 7. However, it further comprises four low-pressure compressor stages 160, 162, 164, 166. The rotor of the first low-pressure compressor stage 160 receiving the primary flow F1 corresponds to the fan 22. The other three compressor stages 162, 164, and 166 use the rotors 134, 132, and 130 of the low-pressure turbine stages 124, 126, and 128, respectively.

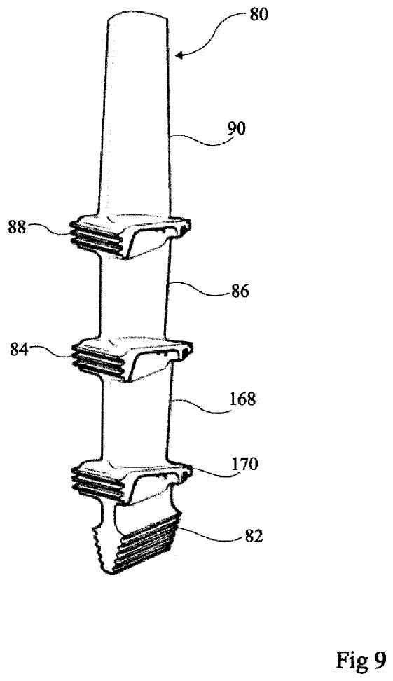

FIG. 9 is a perspective view of the blade 80 of the fan for the embodiment shown in FIG. 8. With respect to FIG. 4, each blade 80 of the fan 22 for the embodiment shown in FIG. 8 further comprises a blade portion 168 shaped to act as a compressor blade and which is interposed between the platform 84 and the root 82, with an additional platform 170 being provided between the blade portion 168 and the root 82. The embodiment of the blade 80 shown in FIG. 9 thus comprises, from the axis of rotation toward the periphery of the fan, the root 82, the platform 170, the blade portion 168 acting as a BP compressor blade, the platform 84, the blade portion 86 acting as a BP turbine blade, the platform 88, and the blade portion 90 acting as a fan blade.

Each rotor blade 130, 132, or 134 may have a shape similar to the embodiment of the blade 80 shown in FIG. 4 and comprise a blade portion shaped to act as a turbine rotor blade and a blade portion shaped to act as a compressor rotor blade. In the present embodiment, for each rotor blade 130, 132, or 134, the blade portion shaped to act as a compressor rotor blade is closer to the axis D than the blade portion shaped to act as a turbine rotor blade.

The high-pressure coupling HP comprises the axial compressor 142, the radial compressor 144, and the high-pressure turbine stage 50 as previously described in relation to FIG. 7, with the difference that the rotor 58 of the high-pressure turbine stage 50 also corresponds to the rotor of the axial compressor 142. Furthermore, each blade of the rotor 58 thus comprises a blade portion shaped to act as a turbine rotor blade and a blade portion shaped to act as a compressor rotor blade. In the present embodiment, for each rotor blade 58, the blade portion shaped to act as a compressor rotor blade is closer to the axis D than the blade portion shaped to act as a turbine rotor blade.

In the embodiment shown in FIG. 8, the primary flow flows from upstream to downstream with respect to the turbofan engine 40 as it passes through the low-pressure compressor stages 160, 162, 164, and 166 and the axial compressor 142 of the high-pressure coupling. The primary flow flows from downstream to upstream relative to the turbofan engine 40 as it passes through the radial compressor 144, the combustion chamber 156, the high-pressure turbine stage 50, and the low-pressure turbine stages 124, 126, 128, and 62.

An example application of the turbofan engines described above relates to a drone comprising a body equipped with turbofan engines as described above. The turbofan engines can be mounted so as to be pivotable with respect to the body of the drone. Thus, in a vertical take-off or landing phase, the axis D of each turbofan engine can be substantially vertical, and in a horizontal movement phase, the axis D of at least one turbofan engine may be inclined with respect to the vertical. The embodiments of turbofan engines described above are particularly suitable when the movement speed of the drone with respect to the ground is not too high, for example in the take-off and landing phases. When the movement speed of the drone with respect to the ground increases, it may be desirable for the burnt gas output flow N1 to be directed at least in part in the downstream direction of the turbofan engine, as the expelled flow N2. For this purpose, the turbofan engine may comprise a device for reversing the burnt gas output flow N1.

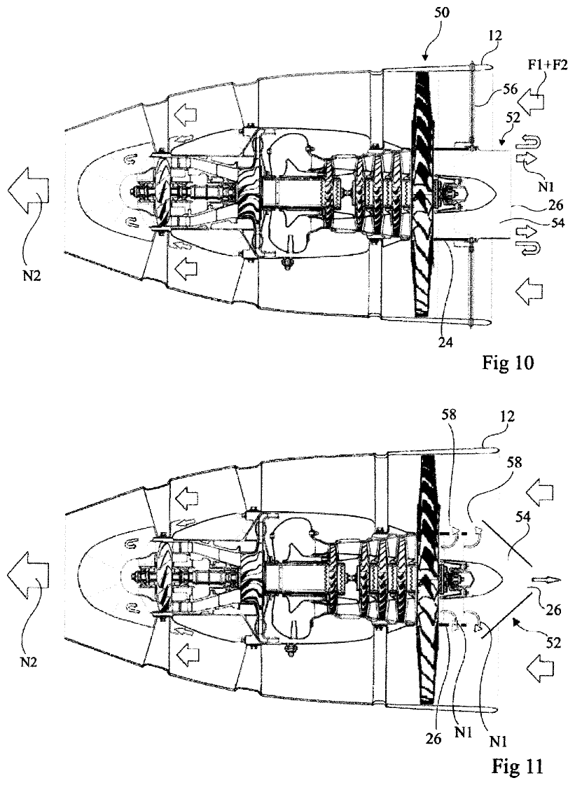

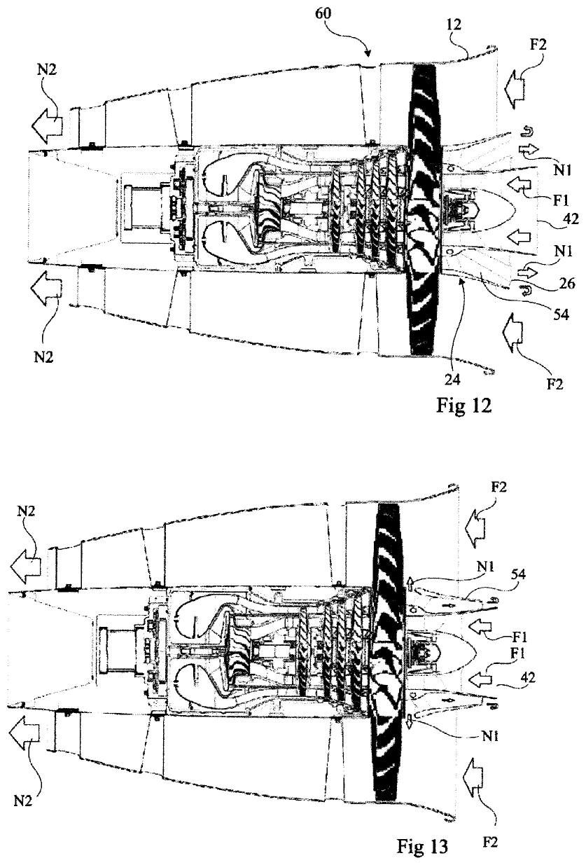

FIGS. 10 and 11 show an embodiment of a turbofan engine 50 in two operating configurations and FIGS. 12 and 13 show an embodiment of a turbofan engine 60 in two operating configurations. The turbofan engine 50 comprises all the elements of the turbofan engine 10 shown in FIG. 7 and the turbofan engine 60 comprises all the elements of the turbofan engine 40 shown in FIG. 8. Each of the turbofan engines 50 and 60 further comprises a device 52 for reversing the burnt gas output flow N1. The device 52 comprises movable flaps 54, which form the terminal portion of the nozzle 24, and a mechanism 56 for actuating the movable flaps 54. The actuation mechanism is schematically shown in FIG. 10 by control spindles connecting the movable flaps 54 to the outer duct 12 and is not shown in FIGS. 11, 12, and 13.

In the operating configuration shown in FIG. 10 and FIG. 12, the movable flaps 54 are arranged so as to form the free end 26 of the nozzle 24 so that the burnt gas output flow N1 flows in the upstream direction of the turbofan engine 50 and 60, in a manner similar to what has been described previously for the turbofan engine 10 and 40. In the operating configuration shown in FIG. 11 and in FIG. 13, the movable flaps 54 are arranged so as to open up openings 58 allowing some, preferably the majority, if not all, of the burnt gas output flow N1 to escape from the nozzle 24 directly in the downstream direction of the turbofan engine 50 and 60 and to join the expelled flow N2. The transition between the two operating configurations is achieved by moving the movable flaps 54 by means of the actuating mechanism 56.

Various embodiments and variants have been described. A person skilled in the art will understand that some features of these various embodiments and variants could be combined, and other variants will be apparent to the person skilled in the art. In particular, in the embodiment shown in FIG. 4, a blade 80 having a so-called fir tree root 82 has been shown. However, other root shapes may be provided, for example dovetail feet. In particular, the person skilled in the art may provide a system for cooling the rotor blades, a system for modifying the pitch angle of the stator blades, etc. Finally, the practical implementation of the embodiments and variants described is within the capabilities of the person skilled in the art from the functional indications given above.

1. A dual-flow turbofan engine comprising a ducted fan and an engine having a nozzle for expelling burnt gases by the engine in the upstream direction of the turbofan engine, the free end of the nozzle being located upstream of the fan.

2. The turbofan engine according to claim 1, intended to receive an airflow divided into a primary flow and a secondary flow, the primary flow feeding the engine and forming the burnt gases ejected in the upstream direction of the turbofan, the secondary flow being ejected in the downstream direction of the turbofan.

3. The turbofan engine according to claim 2, comprising a first duct having a first air inlet at least for the secondary flow, the fan being contained in the first duct, the turbofan engine comprising a second air inlet for the primary flow.

4. The turbofan engine according to claim 3, wherein the second air inlet (28) is located upstream of the first air inlet.

5. The turbofan engine according to claim 1, wherein the dilution rate of the turbofan engine is between 8 and 15.

6. The turbofan engine according to claim 1, wherein the nozzle is divergent.

7. The turbofan engine according to claim 1, wherein the turbofan engine is a dual-spool engine and comprises a low-pressure coupling having at least one low-pressure turbine stage and a high-pressure coupling, wherein a portion of the fan forms the rotor of the low-pressure turbine stage.

8. The turbofan engine according to claim 7, comprising first blades, each first blade comprising a first portion and a second portion, the first portions of the first blades forming the rotor of the low-pressure turbine stage and the second portions of the first blades forming the fan.

9. The turbofan engine according to claim 7, wherein the low-pressure coupling comprises at least one low-pressure compressor stage and wherein another portion of the fan forms the rotor of the low-pressure compressor stage.

10. The turbofan engine according to claim 9, comprising first blades, each first blade comprising a first portion and a second portion, the first portions of the first blades forming the rotor of the low-pressure turbine stage and the second portions of the first blades forming the fan, wherein each first blade further comprises a third portion, the third portions of the first blades forming the rotor of the low-pressure compressor stage.

11. The turbofan engine according to claim 9, wherein the primary flow passes through the low-pressure compressor stage while the primary flow flows from upstream to downstream of the turbofan engine and wherein the burnt gases pass through the low-pressure turbine stage while the burnt gases flow from downstream to upstream of the turbofan engine.

12. The turbofan engine according to claim 7, wherein the low-pressure coupling comprises at least first and second low-pressure turbine stages and first and second low-pressure compressor stages, wherein a portion of the fan forms the rotor of the first low-pressure turbine stage, the turbofan engine comprising second blades, each second blade comprising a first portion and a second portion, the first portions of the second blades forming the rotor of the second low-pressure turbine stage and the second portions of the second blades forming the rotor of the second low-pressure turbine low-pressure compressor stage.

13. The turbofan engine according to claim 1, further comprising movable flaps and a mechanism for actuating the movable flaps between a first position, in which the movable flaps allow the burnt gases to be expelled in the upstream direction of the turbofan engine, and a second position, in which the movable flaps open up openings for expelling the burnt gases in the downstream direction of the turbofan engine.

14. The turbofan engine according to claim 2, wherein the dilution rate of the turbofan engine is between 8 and 15.

15. The turbofan engine according to claim 3, wherein the dilution rate of the turbofan engine is between 8 and 15.

16. The turbofan engine according to claim 4, wherein the dilution rate of the turbofan engine is between 8 and 15.

17. The turbofan engine according to claim 2, wherein the nozzle is divergent.

18. The turbofan engine according to claim 3, wherein the nozzle is divergent.

19. The turbofan engine according to claim 2, wherein the turbofan engine is a dual-spool engine and comprises a low-pressure coupling having at least one low-pressure turbine stage and a high-pressure coupling, wherein a portion of the fan forms the rotor of the low-pressure turbine stage.

20. The turbofan engine according to claim 3, wherein the turbofan engine is a dual-spool engine and comprises a low-pressure coupling having at least one low-pressure turbine stage and a high-pressure coupling, wherein a portion of the fan forms the rotor of the low-pressure turbine stage.
